(19) United States
(12) Patent Application Publication
(10) Pub. No.: US 2026/0312794 A1
(43) Pub. Date: Oct. 8, 2026

(54) SYSTEM AND METHOD FOR RANDOMNESS EXTRACTION AND METHOD OF PERFORMING QUANTUM CRYPTOGRAPHY

(71) Applicant: NATIONAL UNIVERSITY OF SINGAPORE, Singapore (SG)

(72) Inventors: Hong Jie NG, Singapore (SG); Wen Yu KON, Singapore (SG); Ignatius William PRIMAATMAJA, Singapore (SG); Chao WANG, Singapore (SG); Ci Wen LIM, Singapore (SG)

(73) Assignee: NATIONAL UNIVERSITY OF SINGAPORE, Singapore (SG)

(21) Appl. No.: 19/477,301

(22) PCT Filed: Apr. 24, 2024
(86) PCT No.: PCT/SG2024/050267

§ 371 Date: Oct. 21, 2025

(30) Foreign Application Priority Data
Apr. 24, 2023 (SG) 10202301126V

(51) Int. Cl. H04L 9/08; H04L 9/06

(52) U.S. Cl. CPC H04L 9/0852; H04L 9/0643

(57) ABSTRACT

A system and a method for randomness extraction for quantum cryptography and a method of performing quantum cryptography between two or more parties. The system for randomness extraction for quantum cryptography comprises a sampling module configured to sample a cryptographic key to generate one or more sub-blocks; an entropy module configured to determine a lower bound of the entropy in each sub-block, wherein the determining of the lower bound comprises consideration of correlations between each sub-block and unsampled bits of the cryptographic key and/or other sub-blocks; and a hashing module configured to hash each sub-block for randomness extraction on each sub-block.

### FIELD OF INVENTION

The present invention relates broadly to a system and a method for randomness extraction for quantum cryptography and to a method of performing quantum cryptography between two or more parties.

### BACKGROUND

Any mention and/or discussion of prior art throughout the specification should not be considered, in any way, as an admission that this prior art is well known or forms part of common general knowledge in the field.

All practical implementations of quantum cryptographic protocols have finite resources, and thus, suffer from statistical fluctuations in finite-size data. Such statistical fluctuations must be taken into account to ensure that the protocol is information-theoretically secure. This introduces the requirement that the size of the data collected has to be large. However, a large data size is detrimental for hashing, which is one of the necessary steps in both quantum key distribution (QKD) and quantum random number generation (QRNG). This is because a large data size severely slows down the execution of the hashing function, which has an execution time that increases superlinearly with respect to the data size. For the above reasons, hashing is widely known to be the bottleneck of QKD and QRNG implementations.

In more detail, implemented quantum cryptographic protocols are run for a finite duration, and therefore have finite resources. Because of the statistical fluctuations in finite-size data, randomness extraction has to be performed on large input sizes for practical implementations of quantum cryptographic protocols. For example, in QKD, finite-size analysis requires a block size of at least 10⁶ bits. When one is considering protocols with weaker assumptions, such as in the measurement-device-independent setting and the device-independent setting, the block size required is even larger, around 10¹¹ bits.

If one takes device-independent QKD as an example, despite improvements from both theoretical and experimental aspects, the required block size is still larger than the input sizes of state-of-the-art implementations of Toeplitz hashing on FPGAs. This is because the hashing process becomes increasingly impractical as the input size increases. This can be attributed to two scenarios, which are a decrease in throughput or an increase in resources required. As the input size of hashing increases, the output speed naturally decreases, as a larger number of bits have to be processed to produce even a single secure bit. Alternatively, to prevent the throughput of hashing from decreasing, the FPGA can create duplicates of certain hardware and execute them in parallel. However, this leads to a large increase in resource utilization, which restricts the quantum cryptographic system to the use of high-end FPGAs.

Embodiments of the present invention seek to address at least one of the above problems.

### SUMMARY

In accordance with a first aspect of the present invention, there is provided a system for randomness extraction for quantum cryptography, comprising
a sampling module configured to sample a cryptographic key to generate one or more sub-blocks;
an entropy module configured to determine a lower bound of the entropy in each sub-block, wherein the determining of the lower bound comprises consideration of correlations between each sub-block and unsampled bits of the cryptographic key and/or other sub-blocks; and
a hashing module configured to hash each sub-block for randomness extraction on each sub-block.

In accordance with a second aspect of the present invention, there is provided a method of randomness extraction for quantum cryptography, comprising the steps of
sampling a cryptographic key to generate one or more sub-blocks;
determining a lower bound of the entropy in each sub-block, wherein the determining of the lower bound comprises consideration of correlations between each sub-block and unsampled bits of the cryptographic key and/or other sub-blocks; and
hashing each sub-block for randomness extraction on each sub-block.

In accordance with a third aspect of the present invention, there is provided method of performing quantum cryptography between two or more parties, the method comprising announcing a uniform random variable Vᵢ∈[1, N_{S}] identifying which hit of the cryptographic key is sampled into which sub-block.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating the sequential model for the generalized entropy-accumulation theorem (GEAT), where an initial state ρ_{R}_{₀}_{E}_{₀} undergoes a series of GEAT channels, [symbol] ᵢ, to generate the final state ρ_{X}_{^{N}}_{C}_{^{N}}_{R}_{_{N}}_{E}_{_{N}}.

FIG. 2 shows a plot of the key rate per signal sent against the number of sampled sub-blocks (i.e., 1/p_{S}), with and without the sampled sub-block hashing method according to an example embodiment applied.

FIG. 3 shows a plot of the expected key rate per unit time of randomness extraction with and without the sampled sub-block hashing method according to an example embodiment applied.

FIG. 4A shows a comparison of key rate per signal sent versus the number of sampled subblocks. The dashed line represents a target key rate per signal of 0.5. “Full” refers to hashing the sifted key directly, “splitting” refers to use of the sampled subblock hashing method according to an example embodiment, and “small block” refers to our running the QKD protocol for (N/N_{S}) rounds N_{S} times and performing parameter estimation and hashing for each of the N_{S} blocks separately.

FIG. 4B shows a comparison of key rate per unit time versus the number of sampled subblocks. The dashed lines represent the optimal N_{S} value, and its corresponding throughput, that achieves the target key rate per signal for the splitting (N_{S}=17) method and the small-block (N_{S}=4) method. “Full” refers to hashing the sifted key directly, “splitting” refers to use of our sampled subblock hashing method, and “small block” refers to our running the QKD protocol for (N/N_{S}) rounds N_{S} times and performing parameter estimation and hashing for each of the N_{S} blocks separately.

FIG. 5 shows results obtained from the NIST 800-22 statistical test suite for an example embodiment.

FIG. 6A shows Minimum P Value results obtained from the National Institute of Standards and Technology 800-22 statistical test suite for the concatenated output of 152.56 Mbits according to an example embodiment.

FIG. 6B shows Min Proportion results obtained from the National Institute of Standards and Technology 800-22 statistical test suite for the concatenated output of 152.56 Mbits according to an example embodiment.

FIG. 7 shows a schematic drawing illustrating a system 700 for randomness extraction for quantum cryptography according to an example embodiment.

FIG. 8 shows a flowchart 800 illustrating a method of randomness extraction for quantum cryptography, according to an example embodiment.

### DETAILED DESCRIPTION

A generic N-round protocol, with honest parties (or a single honest party) and an adversary typically has the following steps:
(1) Data generation. The honest parties exchange classical and quantum information for N rounds, which could be attacked by the adversary. At the end of each round of exchange, the honest parties receive a raw bit string Aᵢ, with the honest parties publicly exchanging information Iᵢ, and with the adversary holding side information Eᵢ. It is assumed that Aᵢ is generated independently from any memory (from previous rounds) that the honest parties possesses.
(2) Statistical check. Honest parties assign each round of the data generation as either a test round (Tᵢ=1) or a data-generation round (Tᵢ=0), with testing probability γ. For test rounds, the honest parties announce information

$${I}_{i}^{test} ,$$

which includes Aᵢ, and compute statistics Cᵢ. On the basis of the observed statistics C^{N}, the protocol aborts if they do not fall into the set of events Ω.
(3) Additional information exchange. Additional public information can be exchanged by the honest parties, labelled Y, which is not generated in a round-by-round manner (for instance, error correction).
(4) Sifting. Honest users discard rounds that are inconclusive (for instance, due to loss or no detection) and part of the test rounds, arriving at a shorter sifted bit string A′.
(5) Randomness extraction. Randomness extraction is performed on the sifted bit string A′ to obtain output K=ƒ_{RE}(A′), where ƒ_{RE} is a hash function randomly chosen from a family of two-universal hash functions.

At the end of the protocol, the adversary will have information

$${E}_{N}^{′} = {T}^{N} {{I}^{N} ( {I}^{test} )}^{N} {E}_{N} ,$$

along with Y and the hash function F_{RE}.

After randomness extraction, one ideally wants the hashed output K to be secret from the adversary. Accordingly, bounds on the penalty due to the announcements can be provided, for instance, with use of tighter min-entropy chain rules.

To ensure that (1) the quantum cryptographic protocol satisfies the finite-size effect; and (2) the hashing step remains practical, embodiments of the present invention implement a sampled sub-block hashing method to improve current hashing implementations.

In more detail, in example embodiments of the present invention, the large-input data on which randomness extraction is to be performed is randomly split (via sampling) into subblocks, and a lower bound is provided on the conditional smooth min-entropy of each subblock, noting that the correlation between different sub-blocks is considered in the entropy determination step.

In one example embodiment, for single round sampling, where the input data is reduced to one sampled sub-block, and randomness extraction is performed on that sub-block accounting for the correlation between different sampled sub-blocks, i.e. in this example embodiment between the bits randomly sampled into the one sub-block and the unsampled bits. This contrasts with discarding the unsampled bits, which would effectively introduce a large loss of entropy, as has been recognised by the present inventors.

In another example embodiment, the input data is sampled into multiple sampled sub-blocks, and randomness extraction is performed on each sub-block independently, before all the outputs are concatenated together. In this example embodiment, the method can account for the correlation between different sampled sub-blocks. Thus, the present method is operable to perform hashing on all the sub-blocks and concatenate the outputs while still preserving the overall security.

In order to demonstrate the performance of example embodiments of the present invention, a theoretical assessment is made when the hashing method according to an example embodiment is performed on a protocol satisfying certain properties and whose security can be analysed with the recent generalized entropy-accumulation theorem (GEAT), which demonstrates that the hashing method according to an example embodiment introduces only a small (linear) loss in security while providing a linear improvement in the speed of randomness extraction and maintaining the same number of secure bits obtained. It is noted that to obtain this lower bound, i.e. the entropy determination, GEAT can be replaced using other methods that are, or may become to be available for determining the entropy while accounting for the correlation between one sampled sub-block and the unsampled bits and/or between different sampled sub-blocks.

An example embodiment of the present invention makes use of the generalised entropy accumulation theorem (GEAT) [T. Metger, O. Fawzi, D. Sutter, and R. Renner, in 2022 IEEE 63rd Annual Symposium on Foundations of Computer Science (FOCS) (IEEE Computer Society, Denver, CO, USA, 2022), p. 844], which will be first briefly described below, using QKD as an example. Suppose that a QKD protocol can be analysed with the GEAT, with the raw string having some min-entropy

$${H}_{min}^{ε} ( {X}^{n} \vert {E}_{n} ) \geq n h - {c}_{1} \sqrt{n} - {c}_{0} \qquad ( 1 )$$

$$where$$

$$h = {min}_{v ∈ Λ} f ( v )$$

$$f ( v ) \leq {min}_{ρ ∈ {Σ}_{i} 1 ( v )} {H ( {X}_{i} \vert {E}_{i} )}_{ρ}$$

$${\sum }_{i} ( ν ) = \{ {ρ}_{{C}_{t} {X}_{i} {E}_{i} {\tilde{E}}_{i - 1}} = {ℳ}_{i} ( {σ}_{{R}_{i - 1} {E}_{i - 1} {\tilde{E}}_{i - 1}} ) \vert {ρ}_{{C}_{i}} = v \} ,$$

and where n is the total number of rounds (or signals exchanged) during the protocol, ƒ is the min-tradeoff function present in GEAT, Cᵢ is the test statistic, σ_{R}_{ᵢ₋₁}_{E}_{ᵢ₋₁}_{Ē}_{ᵢ₋₁} is the state before the GEAT channel, [symbol] ᵢ is the GEAT channel, Xᵢ is the sifted bit string, and Λ is the set of accepted statistics that would not trigger an abort of the protocol.

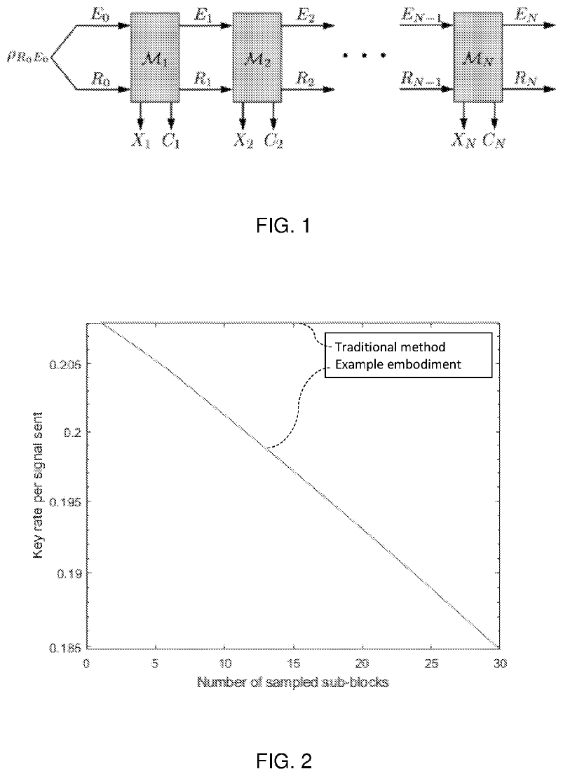

More specifically, the GEAT is used to prove the utility of example embodiments, and a brief description of GEAT is provided here. Suppose at the end of some protocol, one has the output quantum state ρ_{X}_{^{N}}_{C}_{^{N}}_{R}_{_{N}}_{E}_{_{N}}, which can be described as being generated by applying a sequence of channels [symbol] ₁, . . . , [symbol] _{N} (termed “GEAT channels”), [symbol] ᵢ:Rᵢ₋₁Eᵢ₋₁→XᵢRᵢCᵢEᵢ, on some initial state ρ_{R}_{₀}_{E}_{₀} (see FIG. 1 X^{N}=X₁, . . . , X_{N} typically refers to the output (e.g., raw keys in QKD), C^{N}=C₁, . . . , C_{N} refers to the statistics used to select an event (e.g., whether the protocol should be aborted), Rᵢ is the side information carried by Alice and Bob, and Eᵢ is Eve's side information. The GEAT provides a fairly tight bound on the conditional smooth min-entropy of the output X^{N} conditioned on the side information E_{N}, i.e.,

$${H}_{min}^{ε} ( {X}^{N} \vert {E}_{N} ) .$$

The entropy is evaluated on the state ρ_{X}_{^{N}}_{C}_{^{N}}_{R}_{_{N}}_{E}_{_{N}}_{|Ω} where Ω⊂C^{N} is a set of events. This bound is extremely useful as it is directly related to the final key length and the security parameter in quantum cryptographic protocols.

The GEAT states, that if the two conditions described below are satisfied, then

$${H}_{min}^{ε} ( {X}^{N} \vert {E}_{N} ) \geq N h - {v}_{1} \cdot \sqrt{N} - {v}_{0} , \qquad ( 2 )$$

$$where$$

$$h = {min}_{{c}^{N} ∈ Ω} f ( freq ( {c}^{N} ) ) ,$$

$${v}_{0} = \frac{β ( ε )}{{V}^{2}} {2}^{\frac{1 - ξ}{ξ} v} {ln}^{3} ( {2}^{v} + {e}^{2} ) , {v}_{1} = γ ( ε ) V ,$$

$$v = 2 {log}_{2} ( {d}_{X} ) + Max ( f ) - Min ( f ) ,$$

$$V = {log}_{2} ( 2 {d}_{X}^{2} + 1 ) + \sqrt{2 + Var ( f ) ,}$$

with variables ξ, γ, and β, which are independent of ƒ, and Var(ƒ), Max(ƒ) and Min(ƒ) as the variance, maximum value, and minimum value of some affine min-trade-off function ƒ(q). The two conditions are:
(1) Nonsignaling. One requires that any side information that Eve can have about X₁, . . . , Xᵢ₋₁ should already be contained in Eᵢ₋₁, and not stored in Rᵢ₋₁ and revealed in later rounds (for instance, to Eᵢ). More formally, for each GEAT channel [symbol] ᵢ, there exists a channel [symbol] ᵢ: Eᵢ₋₁→Eᵢ such that

$${Tr}_{{x}_{i} {R}_{i} {C}_{i}} ∘ {ℳ}_{i} = {ℛ}_{i} ∘ {Tr}_{{R}_{t - 1}} ,$$

where ∘ represents the composition of the channels.
(2) Projective reconstructability. One should be able to reconstruct statistics C^{N} by performing a projective measurement on X^{N} and E_{N}, and applying a function on the outcomes. More formally, there exists a channel [symbol] such that

$${ℳ}_{N} ∘ ⋯ ∘ {ℳ}_{1} = \text{?} ∘ {Tr}_{{C}_{N}} ∘ {ℳ}_{N} ∘ ⋯ ∘ {Tr}_{{C}_{1}} ∘ {ℳ}_{1} .$$

The min-trade-off function is an affine function f(q), where for all i=1, . . . , N,

$$f ( q ) \leq {min}_{ρ ∈ {Σ}_{i} ( q )} {H ( {X}_{i} \vert {E}_{t} , \text{?} )}_{{ρ}^{′}} \qquad ( 3 )$$

with Σᵢ(q)={ρ| [symbol] = [symbol] ᵢ( [symbol] ), ρ_{C}_{ᵢ}=q} and [symbol] as a purifying system of Rᵢ₋₁Eᵢ₋₁.

It is noted that any protocol that cannot be analyzed with the GEAT framework may still have utility if an alternative proof theory can be applied and satisfied. This includes quantum cryptography protocols that in general cannot be reduced to a sequential process that obeys the nonsignaling condition according to the GEAT.

According to example embodiments, a sampling method is considered where each round is sampled randomly, with some probability p_{S}. In this scenario, it is possible to define an appropriate GEAT channel to compute the min-entropy

$${H}_{min}^{ε} ( {X}_{S} \vert {E}_{n} S )$$

of sub-block X_{S} by announcing Sᵢ during the protocol and including only Xᵢ that are in the sampled sub-block X_{S}.

In more detail, a sampled subblock hashing protocol is used in an example embodiment. One begins with the raw bit string A^{N}=(A₁, . . . , A_{N}) from a cryptographic key generation module, which is understood in the art and will not be described herein. By way of example, not limitation, reference is made to description of QKD key generation modules in a recent review of protocols and implementation in [Feihu Xu, Xiongfeng Ma, Qiang Zhang, Hoi-Kwong Lo, and Jian-Wei Pan, Rev. Mod. Phys. 92, 025002 (2020)], and to description of QRNG key generation modules to a review of protocols and implementation in [Ma, X., Yuan, X., Cao, Z. et al. Quantum random number generation. npj Quantum Inf 2, 16021 (2016)]. The raw bit string A^{N}=(A₁, . . . , A_{N}) is supposed to undergo sifting and randomness extraction, p_{S} be the sampling probability and N_{S}=1/ [symbol] is chosen such that there are N_{S}∈ [symbol] . The sampled sub-block hashing method according to an example embodiment comprises:
(1) Sampling. For each round i∈[1, N], the honest parties generate a uniform random variable Vᵢ, which can take values vᵢ∈[1,N_{S}] (i.e., Vᵢ can take values from 1 to N_{S}, each with probability p_{S}). In an example embodiment, if Vᵢ=j, it means that bit Aᵢ is “sampled” into the jth subblock, which is denoted as A_{S}_{ⱼ}, where the indices for a set Sⱼ={i:Vᵢ=j}. The value of Vᵢ is then announced to the rest of the honest parties (if necessary).
(2) Sifting. For each subblock Sⱼ, sifting can be performed to discard rounds that are inconclusive or part of the test rounds, leaving sifted subblocks

$${A}_{{S}_{j}}^{′} .$$

In general, the length of these bit strings is not fixed. Therefore, to prevent an excessively long bit string from slowing the Toeplitz hashing, in a preferred example embodiment one can choose to abort if the size of any sifted subblocks

$${A}_{{S}_{j}}^{′}$$

exceeds a predetermined threshold

$${L}_{S}^{UB} .$$

In practice, this aborting probability would be very small.
(3) Randomness extraction. If the protocol according to an example embodiment does not abort, randomness extraction is performed on all the subblocks independently to yield output

$${K}_{j} = {f}_{RE , j} ( {A}_{{S}_{j}}^{′} ) ,$$

where ƒ_{RE,j} are random hash functions chosen independently from a family of two-universal hash functions. For simplicity, the length of output Kⱼ is taken to be l̅ for every j.
(4) Concatenation. The final output, denoted by K=(K₁, . . . , K_{N}_{_{S}}), is obtained by concatenation of all the individual outputs of randomness extraction on each subblock.

It is noted that when the sampled subblock hashing according to an example embodiment is applied, Vᵢ is additionally announced, along with the use of multiple hash functions, ƒ_{RE,1} . . . ƒ_{RE,N}_{_{S}}, and would be accessible to the adversary, which is considered in the security assessment of the example embodiment.

In the example embodiment, when multiple hashed strings are concatenated, the min-entropy of each sub-block to be computed is

$${H}_{min}^{ε} ( {A}_{{S}_{i}}^{′} \vert {E}_{N} , {V}^{N} , Y , {F}_{RE}^{{N}_{s}} , {A}_{{S}_{t + 1}}^{′} , … , {A}_{{S}_{{N}_{s}}}^{′} )$$

to account for correlations between sub-blocks. With appropriate GEAT channels announcing Xᵢ for non-sampled rounds, the min-entropy value for each sub-block can be computed. Again, it is noted that to obtain this lower bound, i.e. the entropy determination, GEAT can be replaced using other methods that are, or may become to be available for determining the entropy while accounting for the correlation between one sampled sub-block and the unsampled bits and/or between different sampled sub-blocks.

Generally, for the security analysis demonstrating the utility of an example embodiment it is assumed that for each subprotocol, i.e. for each sub-block, the associated smooth min-entropy is of the form

$${H}_{min}^{{ε}_{sm}} ( {A}_{{S}_{j}}^{′} \vert {A}_{{S}_{j + 1}}^{′} ⋯ {A}_{{S}_{{N}_{s}}}^{′} , {V}^{N} , {E}_{N} ) , \qquad ( 4 )$$

which accounts for correlations between the sampled raw bit strings. Since the original protocol to which the sampled sub-block hashing method according to an example embodiment is applied is GEAT-analyzable, one is able to write down GEAT channels Mᵢ and apply the EAT by defining some min-trade-off function f(q). To construct the min-trade-off function for the sampled sub-block hashing method according to an example embodiment applied to the original protocol, one can adapt the EAT channel to output

$${A}_{{S}_{j} , i}^{′}$$

(note

$${A}_{{S}_{j} , i}^{′} = ⊥$$

is inserted if the ith round is discarded or not included in

$${A}_{{S}_{j}}^{′} )$$

while forwarding the information

$${A}_{{S}_{j + 1} , i}^{′} … {A}_{{S}_{{N}_{S}} , i}^{′}$$

and Vᵢ) to Eve. Since only a fraction ps of the bits

$${A}_{i}^{′}$$

is output as

$${A}_{{S}_{j} , i}^{′} ,$$

the entropy and thus the min-trade-off function gain a factor of pₛ=1/N_{S}, giving the modification in the claim.

The security condition of concern is

$${P}_{Ω} {Δ}_{T} ( {ρ}_{{KV}^{N} {E}_{N}^{′} {F}_{RE}^{{N}_{S}} Y \vert Ω} , {τ}_{K} ⊗ {ρ}_{{V}^{N} {E}_{N}^{′} {F}_{RE}^{{N}_{S}} Y \vert Ω} ) \leq {ε}^{′} , \qquad ( 5 )$$

where one can guarantee the bit string K is secret from the adversary, who has access to

$${V}^{N} {E}_{N}^{′} {F}_{RE}^{{N}_{S}} Y .$$

By introducing an intermediate state of the form

$${τ}_{{K}_{1} … {K}_{j}} ⊗ {ρ}_{{K}_{j + 1} … {K}_{{N}_{S}} {V}^{N} {E}_{N}^{′} {F}_{R E}^{{N}_{S}} Y \vert Ω} ,$$

one can apply the triangle inequality to arrive at

$${p}_{Ω} {Δ}_{t} ( {ρ}_{{KV}^{N} {E}_{N}^{′} {F}_{R E}^{{N}_{S}} Y \vert Ω} , {τ}_{K} ⊗ {ρ}_{{V}^{N} {E}_{N}^{′} {F}_{R E}^{{N}_{S}} Y \vert Ω} ) \leq {p}_{Ω} {{\sum }^{{N}_{S}}}_{j = 1} {Δ}_{t} ( {ρ}_{{K}_{j} … {K}_{{N}_{S}} {V}^{N} {E}_{N}^{′} {F}_{R E}^{{N}_{S}} Y \vert Ω} , {τ}_{{K}_{j}} ⊗ {ρ}_{{K}_{j + 1} … {K}_{{N}_{S}} {V}^{N} {E}_{N}^{′} {F}_{R E}^{{N}_{S}} Y \vert Ω} ) . \qquad ( 6 )$$

Since subblock hashing according to an example embodiment computes each output string

$${K}_{j} = {f}_{RE , j} ( {A}_{{S}_{j}}^{′} ) ,$$

one can apply the quantum leftover-hash lemma [M. Tomamichel, C. Schaffner, A. Smith, and R. Renner, Leftover hashing against quantum side information, IEEE Trans. Inf. Theory 57, 5524 (2011)][M. Tomamichel and A. Leverrier, A largely self-contained and complete security proof for quantum key distribution, Quantum 1, 14 (2017)] on each subblock. Therefore, one could set

$${ε}^{′} = {p}_{Ω} {{\sum }^{{N}_{S}}}_{j = 1} \{ 2 {ε}_{sm , j} + \frac{1}{2} {2}^{- \frac{1}{2} [ {H}_{min}^{{ε}_{sm , j}} ( {A}_{{S}_{j}}^{′} \vert {K}_{j + 1} … {K}_{{N}_{S}} {V}^{N} {E}_{N}^{′} {F}_{RE}^{{N}_{S} \backslash j} Y ) - \overline{l} ]} \} \qquad ( 7 )$$

to achieve the required security level, where the min-entropy is evaluated on

$${ρ}_{{A}_{{S}_{j}}^{′} {K}_{j + 1} … {K}_{{N}_{S}} {V}^{N} {E}_{N}^{′} {F}_{R E}^{{N}_{S} \backslash j} Y \vert Ω} ,$$

and refers to the set of hash functions used except for ƒ_{RE,j}.

To determine the error, the important quantity to compute is the min-entropy. One can begin by lower-bounding the min-entropy using the data-processing inequality, since

$${K}_{i} = {f}_{RE , i} ( {A}_{{S}_{i}}^{′} ) , and {A}_{{S}_{i}}^{′}$$

can be computed from A_{S}_{ᵢ},

$${H}_{min}^{{ε}_{sm , j}} ( {A}_{{S}_{j}}^{′} \vert {K}_{j + 1} … {K}_{{N}_{S}} {V}^{N} {E}_{N}^{′} {F}_{RE}^{{N}_{S} ∖ j} Y ) \geq {H}_{min}^{{ε}_{sm , j}} ( {A}_{{S}_{j}}^{′} \vert {A}_{{S}_{j + 1}}^{′} … {A}_{{S}_{{N}_{S}}}^{′} {V}^{N} {E}_{N}^{′} {F}^{{N}_{S} ∖ j} Y ) \geq {H}_{min}^{{ε}_{sm , j}} ( {A}_{{S}_{j}}^{′} \vert {A}_{{S}_{j + 1}} … {A}_{{S}_{{N}_{S}}} {V}^{N} {E}_{N}^{′} Y ) , \qquad ( 8 )$$

where the second inequality stems from the fact that

$${F}_{RE}^{{N}_{S} ∖ j}$$

is independent of all other terms in the min-entropy.

To analyze the min-entropy with the GEAT, one has to remove the conditioning on Y, which, by definition, cannot be expressed as being generated round by round. Depending on the nature of Y, there are many ways to remove the conditioning with the min-entropy chain rule. Here, one possible efficient method is described by way of example, if Y is generated by blocks according to an example embodiment. Suppose Yⱼ is generated from the information in rounds Sⱼ only,

$$i . e . , {Y}_{j} = g ( {A}_{{S}_{j}}^{′} , {I}_{{S}_{j}} ) .$$

Then one could remove the conditioning with

$${H}_{min}^{{ε}_{sm , j}} ( {A}_{{S}_{j}}^{′} \vert {A}_{{S}_{j + 1}}^{′} … {A}_{{S}_{{N}_{S}}}^{′} {V}^{N} {E}_{N}^{′} Y ) \geq {H}_{min}^{{ε}_{sm , j}} ( {A}_{{S}_{j}}^{′} \vert {A}_{{S}^{\backslash j}}^{′} {V}^{N} {E}_{N}^{′} Y ) \geq {H}_{min}^{{ε}_{sm , j}} ( {A}_{{S}_{j}}^{′} \vert {A}_{{S}^{\backslash j}}^{′} {V}^{N} {E}_{N}^{′} {Y}_{j} ) \geq {H}_{min}^{{ε}_{sm , j}} ( {A}_{{S}_{j}}^{′} \vert {A}_{{S}^{\backslash j}}^{′} {V}^{N} {E}_{N}^{′} ) - {log}_{2} \vert {𝒴}_{j} \vert , \qquad ( 9 )$$

where S^{\j}=U_{i:i≠j}Sᵢ. The second inequality makes use of the property that conditioning does not increase min-entropy, the third inequality uses the data-processing inequality on Yᵢ for i≠j, since [symbol] and I_{S}_{ᵢ} (in

$${E}_{N}^{′} )$$

are present, and the final inequality uses the chain rule. For consistency, however, the min-entropy expansion in the main text is used in the following analysis (incurs a penalty log₂|Y|) but it will be appreciated that it is straightforward to generalize the result to the more-efficient case highlighted here.

Focusing now on the min-entropy term

$${H}_{min}^{{ε}_{sm , j}} ( {A}_{{S}_{j}}^{′} \vert {A}_{{S}_{j + 1}}^{′} … {A}_{{S}_{{N}_{S}}}^{′} {V}^{N} {E}_{N}^{′} ) ,$$

which is now amenable to GEAT analysis, one can define the channel

$$\text{?} : {R}_{i - 1} {E}_{i - 1} \to {R}_{i} {E}_{i} {A}_{{S}_{j} , i}^{′} {C}_{i} ,$$

with

$${E}_{i} = {E}_{i}^{′′} {A}_{{S}_{j + 1} , i}^{′} … {A}_{{S}_{{N}_{S} ,} i}^{′} {V}_{i} ,$$

$$and$$

$${E}_{i}^{′′} = {E}_{i}^{′} {A}_{{S}_{j + 1}}^{′ i - 1} … {A}_{{S}_{{N}_{S}}}^{′ i - 1} {V}^{i - 1}$$

(1) Implement EAT channel [symbol] ᵢ, which maps from

$${R}_{i - 1} {E}_{i - 1}^{′} to {R}_{i} {E}_{i}^{′} {A}_{i}^{′} {C}_{i}$$

(2) Generate a uniformly random variable Vᵢ(step 1 of sample and hash).
(3) Define

$${A}_{{S}_{k} , i}^{′} = \{ \begin{matrix}{A}_{i}^{′} , & {V}_{i} = k \\ ⊥ , & {V}_{i} \neq k\end{matrix} for k = j , … , {N}_{S} .$$

(4) Announce the values of

$${A}_{{S}_{k} {i}^{i}}^{′}$$

for k=j+1, . . . , N_{S} and Vᵢ, i.e., they will be known to the adversary.
(5) Trace out

$${A}_{{i}^{i}}^{′} .$$

Applying this channel yields the state

$${ρ}_{{A}_{{S}_{j}}^{′} … {A}_{{S}_{{N}_{S}}}^{′} {V}^{N} {C}^{N} {R}_{N} {E}_{N}^{′}}$$

at the end of the protocol according to an example embodiment, with

$${E}_{N} = {V}^{N} {A}_{{S}_{j + 1}}^{′} … {A}_{{S}_{{N}_{S}}}^{′} {E}_{N}^{′}$$

being known to the adversary. To show that this is a valid EAT channel, one must check for the two conditions of projective reconstructability and nonsignaling discussed above.

The statistics generated in

$${\{ \text{?} \}}_{i} , {C}^{N} ,$$

is no different from that in { [symbol] }ᵢ. Moreover, since Cᵢ is generated from (I^{test})^{N}, which includes Aᵢ by assumption the same generation method can be used in analyzing [symbol] . Therefore, using [symbol] from the projective reconstructability of the [symbol] ᵢ EAT channel, one can create [symbol] ′, which acts on the expanded

$${E}_{N} = {E}_{N}^{′} {V}^{N} {A}_{{S}_{j + 1}}^{′} … {A}_{{S}_{{N}_{S}}}^{′} with {T}^{′} = T ⊗ {id}_{{V}^{N} {A}_{{S}_{j + 1}}^{′} … {A}_{{S}_{{N}_{S}}}^{′}} .$$

It is clear that

$${T}^{′} ∘ {Tr}_{{C}_{N}} {\tilde{ℳ}}_{N}^{j} ∘ … ∘ {Tr}_{{C}_{1}} {\tilde{ℳ}}_{1}^{j} = {\tilde{ℳ}}_{N}^{j} ∘ … ∘ {\tilde{ℳ}}_{1}^{j} ,$$

and thus

$${\{ \text{?} \}}_{i}$$

satisfies projective reconstructability.

The proof of nonsignaling for an example embodiment relies on the assumption that the original EAT channel Mᵢ is nonsignaling and that

$${A}_{i}^{′}$$

is generated independently of any memory, i.e., Rᵢ₋₁ of the EAT channel. Because of this independence, one could, in general, split the EAT channel [symbol] ᵢ into two parts. The first part ε₁:

$${E}_{i - 1}^{′} \to {A}_{i}^{′} {Q}_{i} {\tilde{E}}_{i}$$

is responsible for the generation of

$${A}_{i}^{′} ,$$

taking only inputs

$${E}_{i - 1}^{′}$$

since it is independent of

$${A}_{i}^{′} ,$$

with modifications to form \tilde{E}ᵢ and possible intermediate systems Qᵢ generated. The second part

$${ε}_{2} : {R}_{i - 1} {\tilde{E}}_{ι} {A}_{i}^{′} {Q}_{i} \to {R}_{i} {E}_{i}^{′} {A}_{i}^{′} {C}_{i}$$

includes the use of Rᵢ₋₁ to arrive at the final output systems of the [symbol] ᵢ channel. Since the first part des not depend on Rᵢ₋₁, the nonsignaling condition will depend only on the second part, i.e., that there exists

$$\text{?} : {A}_{i}^{′} {Q}_{i} {\tilde{E}}_{i} \to {E}_{i}^{′}$$

such that

$${Tr}_{{A}_{i}^{′} {R}_{i}} ∘ {ε}_{2} ∘ {ε}_{1} = \text{?} ∘ {ε}_{1} ∘ T {r}_{{R}_{i - 1}} .$$

Consider the channel [symbol] described above, which can be written as a series of channels,

$$\text{?} = {Tr}_{{A}_{i}^{′}} ∘ {ε}_{{A}_{i}^{′} \to {V}^{i} {A}_{{S}_{j , i}}^{′} … {A}_{{S}_{{N}_{S} , i}}^{′}} ∘ {ℳ}_{i} ,$$

where

$${ε}_{{A}_{i}^{′} \to {V}^{i} {A}_{{S}_{j , i}}^{′} … {A}_{{S}_{{N}_{S} , i}}^{′}}$$

describes the generation of Vᵢ and the sampling step. The order of the maps

$${ε}_{{A}_{i}^{′} \to {V}^{i} {A}_{{S}_{j , i}}^{′} … {A}_{{S}_{{N}_{S} , i}}^{′}}$$

and ε₂ is interchangeable, as neither acts to alter the systems that are inputs to the other channel. Therefore, one has

$$\begin{matrix}{Tr}_{{A}_{{S}_{j} , R}^{′} , {R}_{i}} ∘ {\tilde{ℳ}}_{i}^{j} = {Tr}_{{A}_{{S}_{j} , i}^{′} {R}_{i}} ∘ {Tr}_{{A}_{i}^{′}} ∘ {ε}_{{A}_{i}^{′} \to {V}_{i} {A}_{i}^{′} {A}_{{S}_{j , i}}^{′} ⋯ {A}_{{S}_{{N}_{S} , i}}^{′}} ∘ {ε}_{2} ∘ {ε}_{1} \\ = {Tr}_{{A}_{i}^{′} {R}_{i}} ∘ {ε}_{{A}_{i}^{′} \to {V}_{i} , {A}_{i}^{′} {A}_{{S}_{j + 1 , i}} ⋯ {A}_{{S}_{{N}_{S} , i}}^{′}} ∘ {ε}_{2} ∘ {ε}_{1} \\ = {Tr}_{{A}_{i}^{′} {R}_{i}} ∘ {ε}_{2} ∘ {ε}_{{A}_{i}^{′} \to {V}_{i} {A}_{{S}_{j + 1 , i}}^{′} ⋯ {A}_{{S}_{{N}_{S} , i}}^{′}} ∘ {ε}_{1} \\ = {\tilde{R}}_{i}^{′} ∘ {Tr}_{{R}_{i − 1}} ∘ {ε}_{{A}_{i}^{′} \to {V}_{i} {A}_{{S}_{j + 1 , i}}^{′} ⋯ {A}_{{S}_{{N}_{S} , i}}^{′}} ∘ {ε}_{1} \\ = {\tilde{R}}_{i}^{′} ∘ {ε}_{{A}_{i}^{′} \to {V}_{i} {A}_{{S}_{j + 1 , i}}^{′} ⋯ {A}_{{S}_{{N}_{S} , i}^{′}}} ∘ {ε}_{1} ∘ {Tr}_{{R}_{i − 1}}\end{matrix} ,$$

where the second equality traces out the output

$${A}_{{S}_{j} , i}^{′} ,$$

the fourth equality applies the nonsignaling property, and the final equality swaps the order of the trace over Rᵢ₋₁ since neither ε₁ nor

$${ε}_{{A}_{i}^{′} \to {V}^{i} {A}_{{S}_{j + 1 , i}}^{′} … {A}_{{S}_{{N}_{S} , i}}^{′}}$$

acts on Rᵢ₋₁. Noting that

$${ℛ}_{i} = \text{?} ∘ {ε}_{{A}_{i}^{′} \to {V}^{i} {A}_{{S}_{j + 1 , i}}^{′} … {A}_{{S}_{{N}_{S} , i}}^{′}} ∘$$

ε₁ maps

$${E}_{i - 1} to {E}_{i} = {V}_{i} {E}_{i}^{′} {A}_{{S}_{j + 1}}^{′ i - 1} … {A}_{{S}_{{N}_{S}}}^{′ i - 1} {A}_{{S}_{j + 1 , i}}^{′} … {A}_{{S}_{{N}_{S} , i}}^{′} ,$$

one can see that the channel [symbol] is nonsignaling.

With [symbol] as a valid EAT channel, one can now consider the min-trade-off function to use before the GEAT is applied. In this case, the min-trade-off function has to satisfy

$${f}^{′} ( q ) \leq {min}_{ρ ∈ {Σ}_{i}^{′} ( q )} {H ( {A}_{{S}_{j ,} i}^{′} \vert {A}_{{S}_{j + 1 ,} i}^{′} ⋯ {A}_{{S}_{{N}_{S} , i}}^{′} {V}_{i} {E}_{i}^{″} {\tilde{E}}_{i - 1} )}_{ρ} , \qquad ( 11 )$$

with

$${Σ}_{i}^{′} ( q ) = \{ ρ \vert \text{?} = \text{?} ( \text{?} ) , {ρ}_{{C}_{i}} = q \} ,$$

where

$${E}_{i} = {E}_{i}^{″} {A}_{{S}_{j + 1}}^{′} {⋯A}_{{S}_{{N}_{S}} , i}^{′} {V}_{i} .$$

The von Neumann entropy can be simplified by expansion in terms of different vᵢ values. When

$${v}_{i} \neq j , {A}_{{S}_{j} , i}^{′} = ⊥ ,$$

which has entropy 0 since it is a fixed value. When

$${v}_{i} = j , {A}_{{S}_{j} , i}^{′} = {A}_{i}^{′} and {A}_{{S}_{k} , i}^{′} = ⊥ for k > j .$$

Since vᵢ is fixed as j, with

$${A}_{{S}_{k} , i}^{′}$$

for k>j containing no information on

$${A}_{i}^{′} ,$$

the conditional entropy can be reduced to

$$H ( {A}_{i}^{′} \vert {E}_{i}^{″} \text{?} ) .$$

### Since

$${A}_{{S}_{j + 1}}^{′ i - 1} {⋯A}_{{S}_{{N}_{S}}}^{′ i - 1} {V}^{i - 1}$$

are not used in channel [symbol] , they do not give any information on

$${A}_{i}^{′}$$

and one can obtain

$$H ( {A}_{i}^{′} \vert {E}_{i}^{″} \text{?} = H ( {A}_{i}^{′} \vert {E}_{i}^{′} \text{?} .$$

Moreover, since the generation of

$${A}_{i}^{′}$$

and the generation of [symbol] are fully determined by the channel [symbol] , the states to be optimized over reduce to Σᵢ(q), thus yielding the requirement on the min-trade-off function

$${f}^{′} ( q ) \leq {min}_{ρ ∈ {Σ}_{i} ( q )} {p}_{S} {H ( {A}_{i}^{′} \vert {E}_{i}^{′} {\tilde{E}}_{i - 1} )}_{ρ} , \qquad ( 12 )$$

where the factor ps is due to the probability of vᵢ=j. From the GEAT-analyzable original protocol, there exists a min-trade-off function f(q) that lower-bounds the right-hand side without the factor ps. Therefore, f′(q)=psf(q) is a valid min-trade-off function.

Applying the GEAT using this min-trade-off function, along with EAT channels [symbol] , one arrives at the result in the main text. Since this result applies to all min-entropy terms in Eq. (3) one has

$${ε}^{′} = {p}_{Ω} {\sum }_{i = 1}^{{N}_{S}} \{ 2 {ε}_{sm , f} + \frac{1}{2} {2}^{- \frac{1}{2} [ {Nh}^{′} - {v}_{1}^{′} \sqrt{N} - {v}_{0}^{′} - {log}_{2} \vert 𝒴 \vert - \tilde{l} ]} \} . \qquad ( 13 )$$

If the smoothing parameters are ε_{sm,j}= [symbol] ₛₘ set to be equal for all rounds, ε_{sm,j}= [symbol] ₛₘ, the error reduces to

$${ε}^{′} = {N}_{S} {p}_{Ω} [ 2 {\tilde{ε}}_{sm} + \frac{1}{2} {2}^{- \frac{1}{2} [ {Nh}^{′} - {v}_{1}^{′} \sqrt{N} - {v}_{0}^{′} - {log}_{2} \vert 𝒴 \vert - \tilde{l} ]} ] . \qquad ( 14 )$$

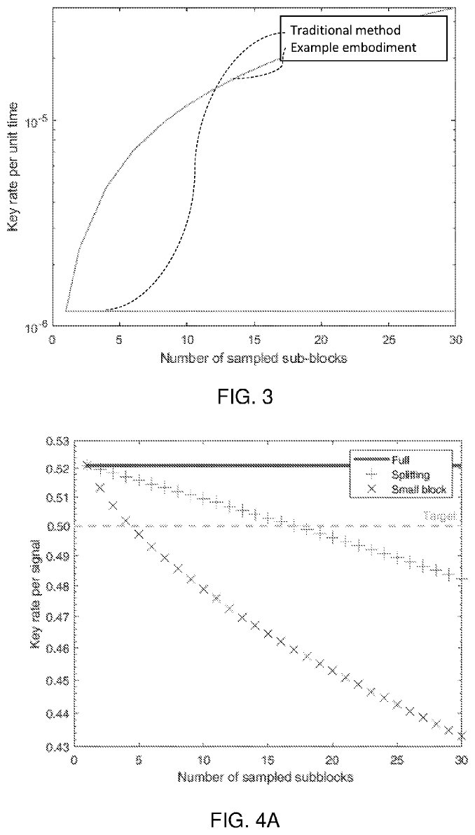

The present invention is demonstrated by employing it on the standard BB84 QKD protocol according to an example embodiment, with n=4×10⁹ number of rounds, assuming a phase and bit error rate of 1%. Optimising the key and test basis probabilities over a range of values of p_{S} using the GEAT, FIG. 2 shows a plot of the key rate per signal sent against the number of sampled sub-blocks (i.e., 1/p_{S}), with and without the sampled sub-block hashing method according to an example embodiment applied. Additionally, FIG. 3 shows a plot of the expected key rate per unit time of randomness extraction with and without the sampled sub-block hashing method according to an example embodiment applied. From FIGS. 2 and 3, it is clear that using the sampled sub-block hashing method according to an example embodiment, there is a small loss in key rate per signal sent, but the speed up that is obtained is large.

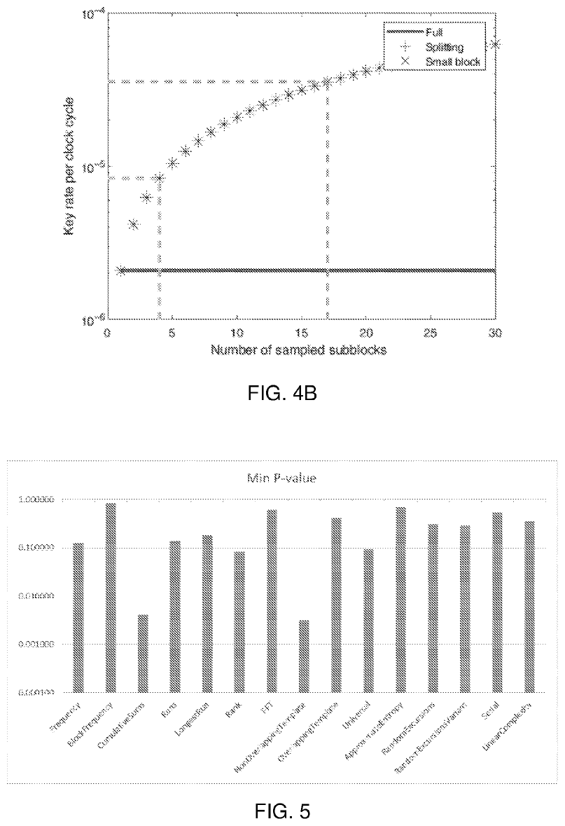

To illustrate the effects of the sampled subblock hashing method according to another example embodiment, a BBM92 protocol is considered with N=10⁹ rounds and secrecy parameter ε_{sec}=1×10⁻⁶. The optimized testing probability p_{X} value for direct hashing is 0.0176, which is rounded to 0.02. This method of choosing p_{X} corresponds to the scenario where an optimized setup has already been achieved and one would like to modify the postprocessing step to increase the throughput. From FIG. 4, it is clear that with use of the sampled sub-block hashing method according to an example embodiment, there is also a small loss in key rate per signal sent, but a linear speedup is obtained. The loss in key rate from sampling, as shown in FIG. 4A, is expected, and is a result of the penalty from sampling. Interestingly, despite the loss, there is an advantage over starting with a smaller block. This may be because the analysis of the sampled sub-block hashing method according to an example embodiment uses the overall statistics of N rounds to estimate the min-entropy of each subprotocol, whereas the small block scenario only uses each protocol's statistics of N/N_{S} rounds. In addition, as the time required scales more favorably for lower input size (based on the clock cycle equation obtained), a shorter subblock would increase the generation rate despite a loss in key length, as seen in FIG. 4B.

A hardware implementation of a method according to an example embodiment is performed with simulated datasets. p_{S}=0.05 was chosen, because at that point, the loss in extractable key length is small, but the increase in execution speed is large. In this example embodiment, the method is implemented on a Xilinx ZCU111 evaluation board and the results are tabulated below. First, Table 1 presents the results of Toeplitz hashing on large block sizes for the example BB84 protocol, without sampling. As expected, when the input size of randomness extraction increases, the speed of the randomness extraction decreases rapidly. This is because to generate even a single bit of output, a larger number of bits needs to be processed first.

TABLE 1

| Input size | 10 Mbit | 100 Mbit | 1 Gbit |
|---|---|---|---|
| Output size | 1 Mbit | 10 Mbit | 10 Mbit |
| Speed (bits/s) | 4,789.43 | 386.47 | 78.51 |

Table 2 presents the results of Toeplitz hashing on large block sizes for the example BB84 protocol, utilizing the method according to an example embodiment. Comparing Tables 1 and 2, it is clear that despite having a larger input size, randomness extraction with the method according to an example embodiment has an execution speed that is faster by almost an order of magnitude. This shows that the method according to an example embodiment allows one to satisfy the finite-size effect without too heavy a penalty on the speed of execution.

TABLE 2

| Input size | 80.919 Mbit | 121.96 Mbit | 410.07 Mbit | 823.08 Mbit | 1.6504 Gbit |
|---|---|---|---|---|---|
| Single block output | 1.3214 Mbit | 2.1976 Mbit | 8.7740 Mbit | 18.578 Mbit | 38.612 Mbit |
| Speed (bits/s) | 11,537.93 | 7,750.65 | 2,329.31 | 1,162.22 | 579.96 |

The results in Table 2 are for single round sampling, where the input data is reduced to 1 sampled sub-block, and randomness extraction is performed on that sub-block. In the next setting according to another example embodiment, a concatenation approach is considered, where the input data from the BB84 example protocol is sampled into three different sub-blocks, by way of example, not limitation, and randomness extraction is performed on each sub-block independently, before all the outputs are concatenated together. The results are presented in Table 3.

TABLE 3

| Input size | 40.034 Mbit | 121.96 Mbit | 410.07 Mbit | 823.08 Mbit |
|---|---|---|---|---|
| Concatenated | 1.494 Mbit | 6.588 Mbit | 26.322 Mbit | 55.728 Mbit |
| output | | | | |
| Speed (bits/s) | 22,982.49 | 7,804.48 | 2,332.75 | 1,163.09 |

Comparing the results from Tables 2 and 3, there is a further improvement in terms of speed when the method is performed with multiple sub-blocks. This is because the time taken for sampling, which only needs to be executed once, is averaged over a greater output size. For a further assessment of an implementation of an example embodiment, the concatenated output of approximately 55.728 Mbit is fed into the NIST 800-22 statistical test suite [A. Rukhin, J. Soto, J. Nechvatal, E. Barker, S. Leigh, M. Levenson, D. Banks, A. Heckert, and J. Dray, NIST 800-22 A Statistical Test Suite for Random and Pseudorandom Number Generators for Cryptographic Applications (2010).39] to test for uniformity. The results are shown in FIG. 5.

A P-value greater than 0.0001 indicates that the sequence under test passes that particular test for uniformity. From FIG. 5, the concatenated output passes all the tests in the test suite. In addition, as the security is maintained by the above-described theoretical model, it can be confidently certified that the output is uniform and secret, even from the adversary.

In another implementation, again p_{S}=0.05 is chosen, because at that point the loss in extractable key length is small but the increase in execution speed is large. A Xilinx ZCU111 evaluation board is used as implementation platform and the results of the BBM92 example protocol are presented in Table 4. As expected, when the input size of randomness extraction increases, the speed of the randomness extraction decreases linearly. This is because to generate even a single bit of output, a larger number of bits needs to be processed first. From comparison between direct hashing (data labelled “traditional method” in table 4) and the example embodiment, the method according to the example embodiment has an execution speed that is faster by almost 20 times. This shows that the example embodiment allows one to satisfy the finite-size effect without too great a penalty on speed. In particular, for the cases where the input size is 960.40 and 1920 Mbits, traditional Toeplitz hashing would have taken approximately 413 and 1695 h, respectively, but our method reduced the timing to 20.73 and 84.99 h, respectively, therefore greatly improving the practicality of large-input hashing.

TABLE 4

Speed (bits/s)

| Input size | Output size | Traditional | Example |
|---|---|---|---|
| (Mbits) | (Mbits) | method | embodiment |
| 96.040 | 6.054 | 498.60 | 9899.80 |
| 192.08 | 13.302 | 249.31 | 4972.47 |
| 288.12 | 20.736 | 166.24 | 3318.63 |
| 960.40 | 74.406 | . . . | 997.05 |
| 1920.00 | 152.56 | . . . | 498.62 |

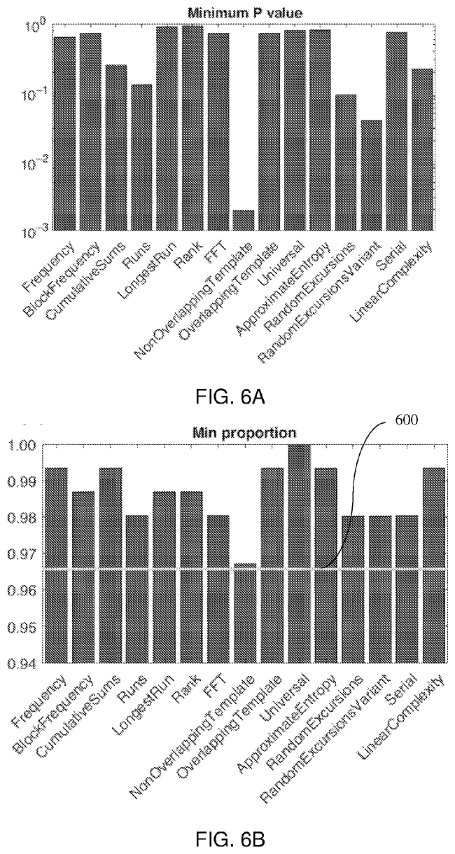

For further assessment of an implementation according to an example embodiment, the concatenated output of 152.56 Mbits is fed into the National Institute of Standards and Technology 800-22 statistical test suite [A. Rukhin, J. Soto, J. Nechvatal, E. Barker, S. Leigh, M. Levenson. D. Banks, A. Heckert. and J. Dray. NIST 800-22 A Statistical Test Suite for Random and Pseudorandom Number Generators for Cryptographic Applications (2010).] to test for uniformity. In FIG. 6A, the P values of each individual test in the test suite are shown. A P value greater than 10-4 indicates that the sequence under test passes that particular test for uniformity. Additionally, in FIG. 6B, the proportion result of each individual test are shown. The proportion result shows the proportion of samples from the sequence under test that passes that particular test. A proportion greater than 0.9657, illustrated by the horizontal line 500 in FIG. 5B, indicates that the sequence under test passes that particular test for uniformity. The combined results show that the concatenated output passes all the tests in the test suite. In addition, as the security is guaranteed by the theoretical model described above, it can again be confidently certified that the output is uniform and secret, even from the adversary.

Table 5 presents the resource utilisation results from the implementation of the method according to an example embodiment on the ZCU111 evaluation kit. The utilisation of look-up table (LUT), LUTRAM, flip-flop (FF), block RAM (BRAM), and digital signal-processing (DSP) blocks are low. The low utilisation percentage also indicates that the entire project can fit on platforms which are smaller and have lower cost.

TABLE 5

| Resource | Utilisation | Utilisation (%) |
|---|---|---|
| LUT | 60,950 | 14.33 |
| LUTRAM | 6,184 | 2.90 |
| FF | 78,685 | 9.25 |
| BRAM | 32.5 | 3.01 |
| DSP | 39 | 0.91 |

As described above, the method according to an example embodiment improves the speed of hashing while accounting for finite-size effects that impose the requirement of large block sizes. The operations required are advantageously straightforward to implement, and the overall security of the entire process is information-theoretic and preserved. Additionally, the method according to an example embodiment can also be implemented on resource-constrained platforms due to its low resource utilization.

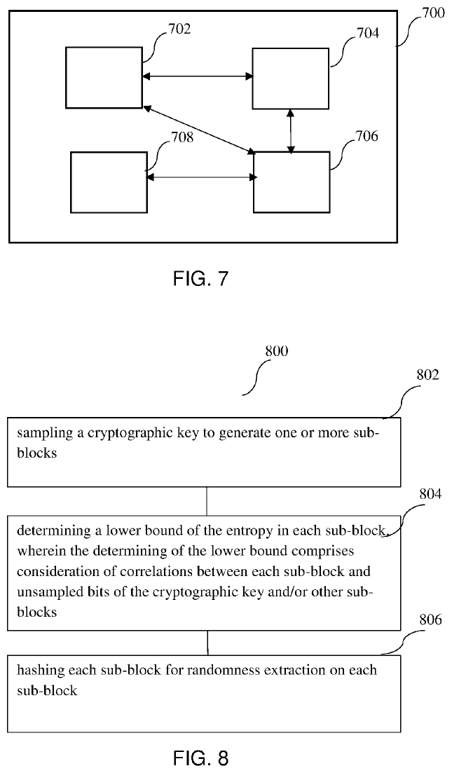

FIG. 7 shows a schematic drawing illustrating a system 700 for randomness extraction for quantum cryptography according to an example embodiment, comprising a sampling module 702 configured to sample a cryptographic key to generate one or more sub-blocks; an entropy module 704 configured to determine a lower bound of the entropy in each sub-block, wherein the determining of the lower bound comprises consideration of correlations between each sub-block and unsampled bits of the cryptographic key and/or other sub-blocks; and a hashing module 706 configured to hash each sub-block for randomness extraction on each sub-block.

The cryptographic key may comprise either a raw key or a sifted key.

The sampling module 702 may be configured to sample the cryptographic key into the one or more sampled sub-blocks in a random manner based on a pre-determined probability.

The system 700 may comprise a sifting module 708 configured to sift the cryptographic key or to sift the one or more sampled sub-blocks.

The sampling module 702 may be configured to apply a thresholding on the length of bit strings representing the respective sub-blocks and to abort the method if the length of the bit string for any sub-block exceeds a predetermined threshold.

The system 700 may comprise a concatenation module configured to concatenate the hashed sub-blocks to generate a secret key.

The entropy module 704 may be configured to determine the lower bound based on the generalized entropy-accumulation theorem.

FIG. 8 shows a flowchart 800 illustrating a method of randomness extraction for quantum cryptography, according to an example embodiment. At step 802, a cryptographic key is sampled to generate one or more sub-blocks. At step 804, a lower bound of the entropy in each sub-block is determined, wherein the determining of the lower bound comprises consideration of correlations between each sub-block and unsampled bits of the cryptographic key and/or other sub-blocks. At step 806, each sub-block is hashed for randomness extraction on each sub-block.

The cryptographic key may comprise either a raw key or a sifted key.

The step of sampling the raw key into the one or more sub-blocks may be performed in a random manner based on a pre-determined probability.

The method may comprise sifting the cryptographic key or sifting the one or more sampled sub-blocks.

The method may comprise applying a thresholding on the length of bit strings representing the respective sub-blocks and aborting the method if the length of the bit string for any sub-block exceeds a predetermined threshold.

The method may comprise concatenating the hashed sub-blocks to generate a secret key.

The step of determining the lower bound may be based on the generalized entropy-accumulation theorem.

In one embodiment, a method of performing quantum cryptography between two or more parties is provided, the method comprising announcing a uniform random variable Vᵢ∈[1, N_{S}] identifying which bit of the cryptographic key is sampled into which sub-block.

The method may use the system for randomness extraction for quantum cryptography of any example embodiment described herein.

The method may comprise using the method for randomness extraction for quantum cryptography of any example embodiment described herein.

### INDUSTRIAL APPLICATIONS OF EXAMPLE EMBODIMENTS

The method according to example embodiments can be useful in all quantum cryptographic protocols. The speed up obtained, together with accounting for finite-size security, are useful features to have in, for example, both QKD and QRNG implementations. As such, the method according to example embodiments can be utilised as a general approach for randomness extraction in both QKD and QRNG systems.

The method according to example embodiments are believed to be especially useful in the measurement-device-independent scheme, as well as the device-independent protocols. This is because such protocols require a large block size to account for finite-size effects, as described herein.

In addition, chip-based implementations of QKD and QRNG systems, which are of keen interest to the industry, can also greatly benefit from the method according to example embodiments. This is because on-chip systems have tight resource-constrains, which would lead to a decrease in throughput due to the finite-size effect. The method according to example embodiments can resolve this issue, allowing finite-size effects to be addressed for on-chip systems without heavy penalties to the speed, with the addition of non-complex operations.

Aspects of the systems and methods described herein, such as the sampling module, the entropy module, the hashing module, and the concatenation module described herein, including in the claims, may be implemented on computing device(s), including cloud-based computing device(s) and/or Internet-of-Things computing device(s), for example as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course, the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A system for randomness extraction for quantum cryptography, comprising
a sampling module configured to sample a cryptographic key to generate one or more sub-blocks;
an entropy module configured to determine a lower bound of the entropy in each sub-block, wherein the determining of the lower bound comprises consideration of correlations between each sub-block and unsampled bits of the cryptographic key and/or other sub-blocks; and
a hashing module configured to hash each sub-block for randomness extraction on each sub-block.

2. The system of claim 1, wherein the cryptographic key comprises either a raw key or a sifted key.

3. The system of claim 1, wherein the sampling module is configured to sample the cryptographic key into the one or more sampled sub-blocks in a random manner based on a pre-determined probability.

4. The system of claim 1, comprising a sifting module configured to sift the cryptographic key or to sift the one or more sampled sub-blocks.

5. The system of claim 1, wherein the sampling module is configured to apply a thresholding on the length of bit strings representing the respective sub-blocks and to abort the method if the length of the bit string for any sub-block exceeds a predetermined threshold.

6. The system of claim 1, comprising a concatenation module configured to concatenate the hashed sub-blocks to generate a secret key.

7. The system of claim 1, wherein the entropy module is configured to determine the lower bound based on the generalized entropy-accumulation theorem.

8. A method of randomness extraction for quantum cryptography, comprising the steps of:
sampling a cryptographic key to generate one or more sub-blocks;
determining a lower bound of the entropy in each sub-block, wherein the determining of the lower bound comprises consideration of correlations between each sub-block and unsampled bits of the cryptographic key and/or other sub-blocks; and
hashing each sub-block for randomness extraction on each sub-block.

9. The method according to claim 8, wherein the cryptographic key comprises either a raw key or a sifted key.

10. The method according to claim 8, wherein the step of sampling the raw key into the one or more sub-blocks is performed in a random manner based on a pre-determined probability.

11. The method of claim 8, comprising sifting the cryptographic key or sifting the one or more sampled sub-blocks.

12. The method of claim 8, comprising applying a thresholding on the length of bit strings representing the respective sub-blocks and aborting the method if the length of the bit string for any sub-block exceeds a predetermined threshold.

13. The method of claim 8, comprising concatenating the hashed sub-blocks to generate a secret key.

14. The method of claim 8, wherein the step of determining the lower bound is based on the generalized entropy-accumulation theorem.

15. A method of performing quantum cryptography between two or more parties, the method comprising announcing a uniform random variable Vᵢ∈[1,N_{S}] identifying which bit of the cryptographic key is sampled into which sub-block.

16. The method of claim 15, using the system for randomness extraction for quantum cryptography of claim 1.

17. The method of claim 15, comprising using the method for randomness extraction for quantum cryptography of claim 8.
